(19) United States
(12) Patent Application Publication
(10) Pub. No.: US 2016/0166014 A1
(43) Pub. Date: Jun. 16, 2016

(54) BUCKLE RELEASE TOOL

(71) Applicants: Joseph Soenen, Lethbridge (CA); Deanndra Cleal, Lethbridge (CA)

(72) Inventors: Joseph Soenen, Lethbridge (CA); Deanndra Cleal, Lethbridge (CA)

(21) Appl. No.: 14/569,625

(22) Filed: Dec. 12, 2014

(51) Int. Cl. A44B 11/25; B66F 19/00; B60R 22/10

(52) U.S. Cl. CPC A44B 11/2526; A44B 11/2511; B60R 22/105; B66F 19/00

(57) ABSTRACT

In one aspect there is provided a buckle release tool for unlatching a buckle assembly, the buckle assembly having a base with an actuator button, for activating a latching mechanism from a latched position to an unlatched position, the buckle assembly further having a fulcrum member. The buckle release tool comprises a body, a first end on the body suitably sized for engaging the fulcrum member of the base for creating a fulcrum for the body to rotate about, an engagement end, spaced from the first end and extending a sufficient amount from the body such that there is sufficient clearance of the body over the base to allow proper depression of actuator button by the engagement end during operation and a second end, for accepting a force thereon.

### FIELD OF THE INVENTION

This invention relates generally to a tool for use with an occupant restraint system. More particularly, the invention relates to a buckle release tool for use in depressing a buckle release mechanism of a car seat restraint harness.

### BACKGROUND OF THE INVENTION

The background information discussed below is presented to better illustrate the novelty and usefulness of the present invention. This background information is not admitted prior art.

Child safety seats are seats designed specifically to protect children from injury or death during automobile collisions. Automobile manufacturers may integrate child safety seats directly into their vehicle's design. Most commonly, these seats are purchased and installed by consumers. Many regions require children defined by age, weight, and/or height to use a government-approved child safety seat when riding in a vehicle. Child safety seats provide passive restraints and must be properly used to be effective. Almost all child safety seats include a five-point harness system for restraining the occupant. The five-point harness consists of five straps. Two straps are located at the shoulders, two at the hips, and one extending from the seat between the occupants legs. All five straps come together, connecting at a buckle release assembly.

The buckle release assembly often comprises a casing which contains a spring loaded latching mechanism for releasably latching the five-point harness together at the buckle. The spring loaded latching mechanism has an actuator, such as a button, for releasing the latching mechanism of the five-point harness. The button is located within an aperture of the casing and the outer surface is often flush with the casing itself. The button is sized to permit an object such as the tip of one finger or a thumb to actuate the buckle release assembly.

The size and position of the button causes a number of difficulties for users when attempting to actuate the buckle release assembly. First, many women who have long fingernails may find it difficult to press the button with the tip of their finger or thumb. Attempting to unlatch the buckle may cause long, brittle, or weak fingernails to crack or break causing pain and discomfort. Also, people may be impaired from actuating the buckle release mechanism in cold weather where typically bulky gloves or mittens are worn to keep hands and fingers warm and comfortable. Finally, some people may have physical conditions which impair their ability to unlatch a buckle, such as arthritis, tendonitis, or any other condition that may cause a weakening of the hands and fingers. Hence, in situations such as those described above, a more convenient way to release the buckle from its latching position is desirable.

U.S. Pat. No. 8,539,862 to Robinson provides one solution to the above described problem. Robinson teaches a buckle release tool including a housing element having a convex back surface ergonomically sized to conform to a human hand and a tool element. The housing element includes a rounded perimeter surface having several shallow slots. A tool element dome is provided on the front surface. A tool element dome includes a soft plastic tip surface.

However, the Buckle Release Tool by Robinson is roughly the size of the palm of an adult hand which makes it large, bulky and inconvenient to carry when needed. Also, the design requires a directly opposing force to activate the button which either puts pressure on the occupant's body, or requires the use of two hands to provide the opposing force on the side of the casing opposite the button to actuate the buckle release mechanism. When dealing with a buckle release mechanism of a child safety seat, such forces and pressures from the tool will then be directly transferred to the child or infant that is being restrained—unless two hands are used. Often, due to the requirement that the child or infant is securely restrained in the safety seat, there is minimal room to fit one's hand behind the buckle release mechanism. It is also often desirable to have one hand free to manage the young occupant of a child car seat while unbuckling the buckle assembly. Finally, Robinson's buckle release tool is made with multiple materials and parts making it expensive to manufacture and assemble.

Accordingly, there exists a need for an improved tool to assist a user for activating a buckle release mechanism.

### SUMMARY OF THE INVENTION

A buckle release tool is provided. The buckle release tool works in conjunction with a buckle assembly, and more specifically a five point harness buckle assembly. The buckle assembly having a base with an actuator button, for activating a latching mechanism from a latched position to an unlatched position, the buckle assembly further having a fulcrum member. The buckle release tool provides a mechanism for depressing the actuator button of a buckle assemble to unlatch the buckle from the base so the occupant of the seat may be removed. The buckle release tool extinguishes the need for a user to depress the actuator button with the tip of a finger. The full pad of a thumb, finger, or the palm of a hand may be used to provide the required force on the buckle release tool to depress the actuator button on the buckle assembly.

In one aspect of the buckle release tool there is provided a body having a first end suitably sized for engaging the fulcrum member of the base for creating a fulcrum for the body to rotate about. An engagement end is spaced from the first end and extends a sufficient amount from the body such that there is sufficient clearance of the body over the base of a buckle assembly to allow proper depression of an actuator button provided therein by the engagement end during operation. A second end is provided for accepting a force upon the body of the buckle release tool. When an input force is applied to the second end, the body pivots about the fulcrum and the engagement end engages the actuator button of the buckle assembly.

### BRIEF DESCRIPTION OF THE DRAWINGS

Referring to the drawings, several aspects of the present invention are illustrated by way of example, and not by way of limitation, in detail in the figures, wherein:

FIG. 1 is a perspective view of one embodiment of a buckle release tool;

FIG. 2 is a side view of the buckle release tool of FIG. 1;

FIG. 3 is a perspective view the buckle release tool of FIG. 1 showing an anchor point for a tensile member to attach thereto;

FIG. 4 is an end view of the buckle release tool of FIG. 1;

FIG. 5A is a side-view of the buckle release tool of FIG. 1 shown aligned above a buckle release assembly in a latched position;

FIG. 5B is a perspective view of the buckle release tool of FIG. 1, shown positioned on the buckle release assembly of FIG. 5A;

FIG. 5C is a perspective view of the buckle release tool of FIG. 1, shown activating an actuator of the buckle release assembly of FIG. 5A;

FIG. 5D is a perspective view of the buckle release tool of FIG. 1, shown activating the actuator of the buckle release assembly of FIG. 5A where the buckle release assembly is shown in an unlatched position;

FIG. 6A is a perspective view of another embodiment of a buckle release tool;

FIG. 6B is a side view of the buckle release tool of FIG. 6A;

FIG. 6C is a side view of the buckle release tool of FIG. 6A, shown aligned with a buckle release assembly in a latched position;

FIG. 6D is a perspective view of the buckle release tool of FIG. 6A, shown positioned on the buckle release assembly of FIG. 6C;

FIG. 6E is a perspective view of the buckle release tool of FIG. 6A, shown activating the actuator of the buckle release assembly of FIG. 6C where the buckle release assembly is in an unlatched position;

FIG. 7A is a perspective view of yet another embodiment of a buckle release tool;

FIG. 7B is a side view of the buckle release tool of FIG. 7A;

FIG. 7C is a side view of the buckle release tool of FIG. 7A shown aligned with a buckle release assembly in a latched position;

FIG. 7D is a perspective view of the buckle release tool of FIG. 7A, shown positioned on the buckle release assembly of FIG. 7C;

FIG. 7E is a perspective view of the buckle release tool of FIG. 7A, shown activating the actuator of the buckle release assembly of FIG. 7C where the buckle release assembly is in an unlatched position;

### DETAILED DESCRIPTION OF THE PREFERRED EMBODIMENTS

The following description is of preferred embodiments by way of example only and without limitation to the combination of features necessary for carrying the invention into effect. Reference is to be had to the Figures in which identical reference numbers identify similar components. The drawing figures are not necessarily to scale and certain features may be shown in schematic or diagrammatic form in the interest of clarity and conciseness.

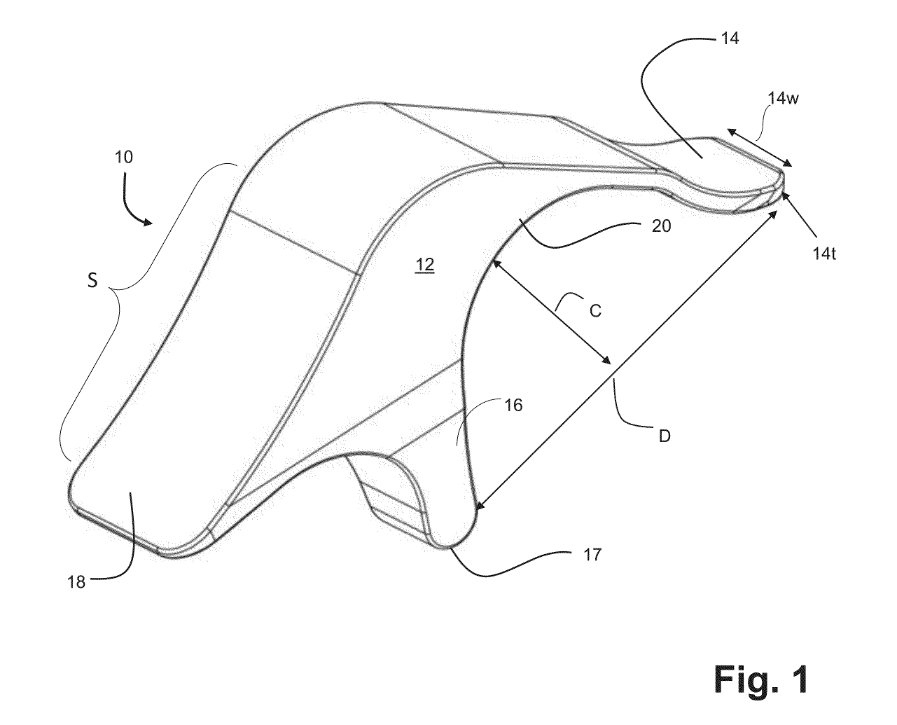

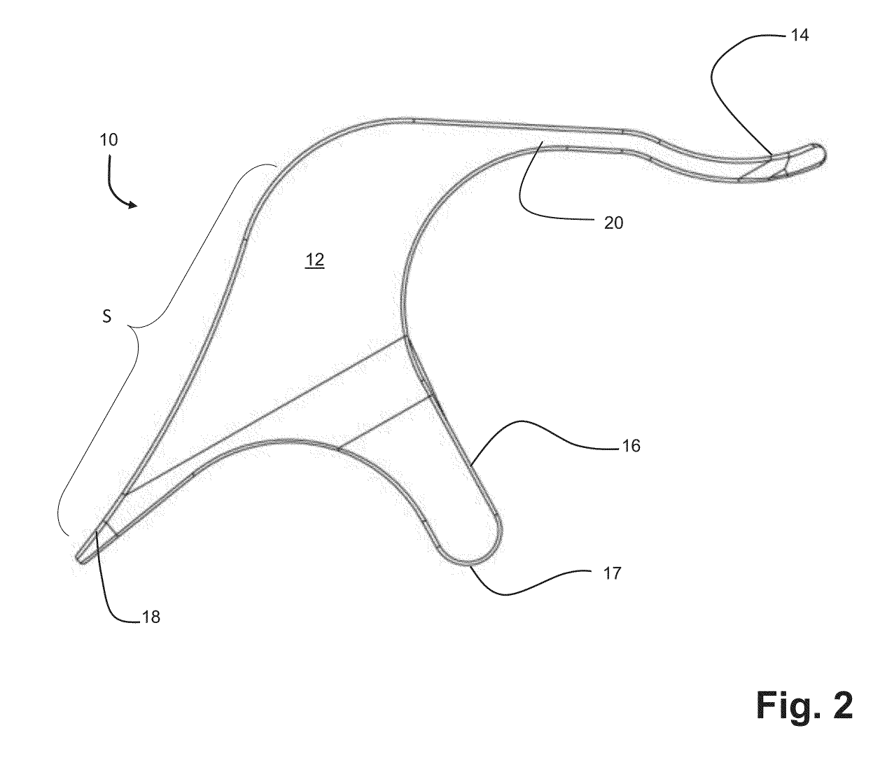

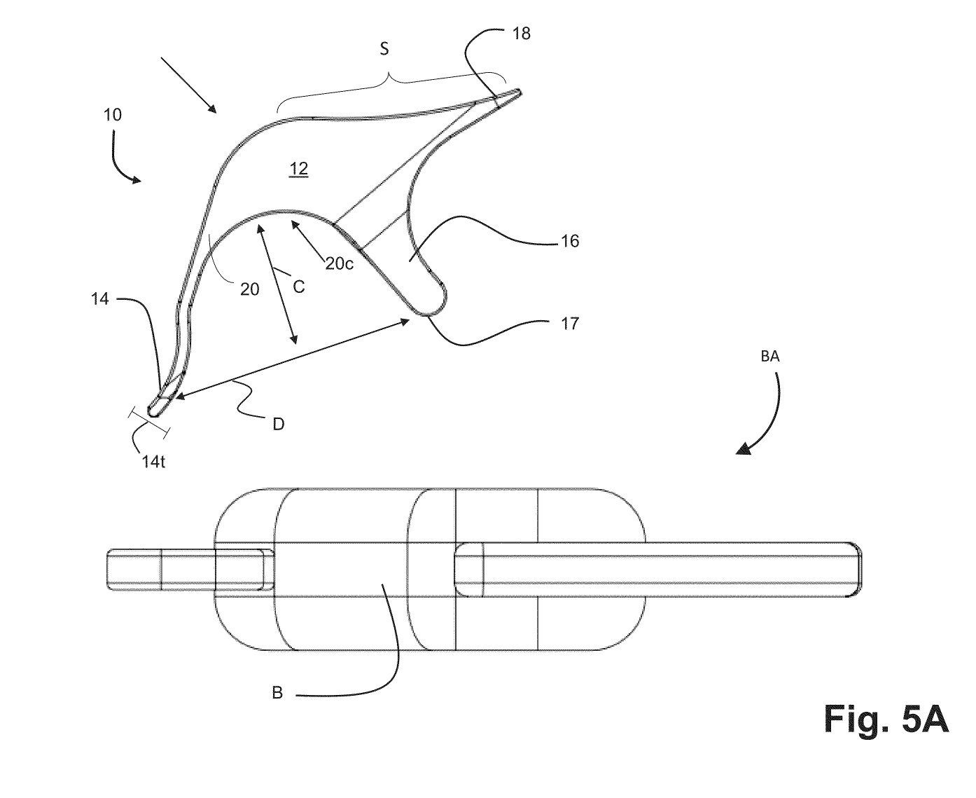

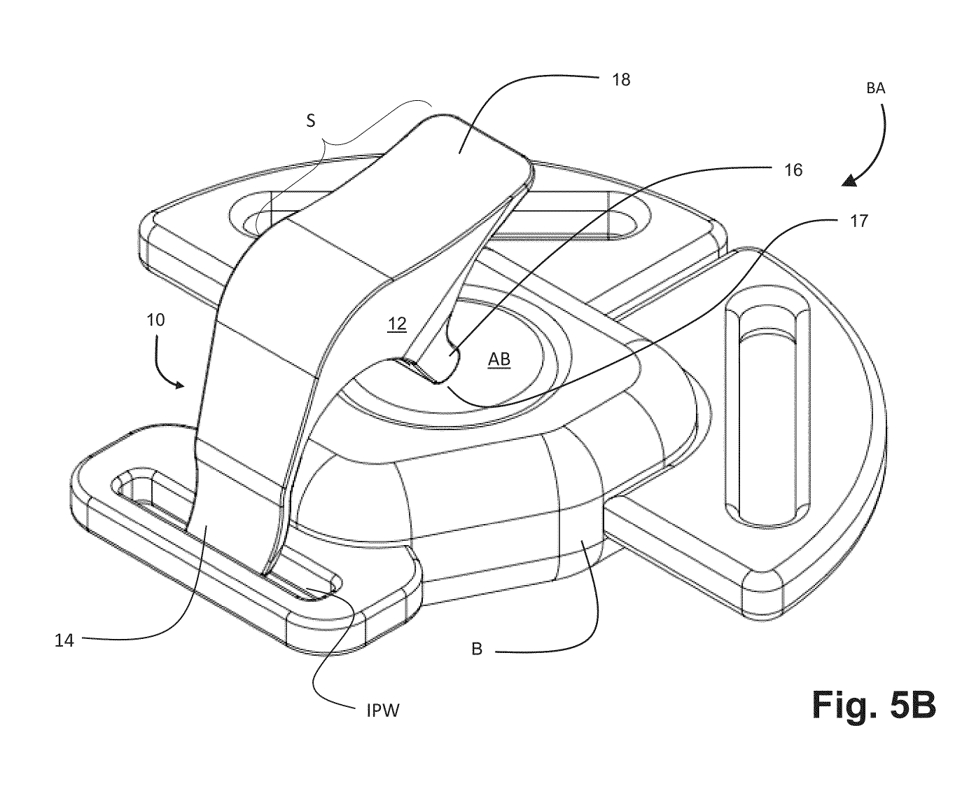

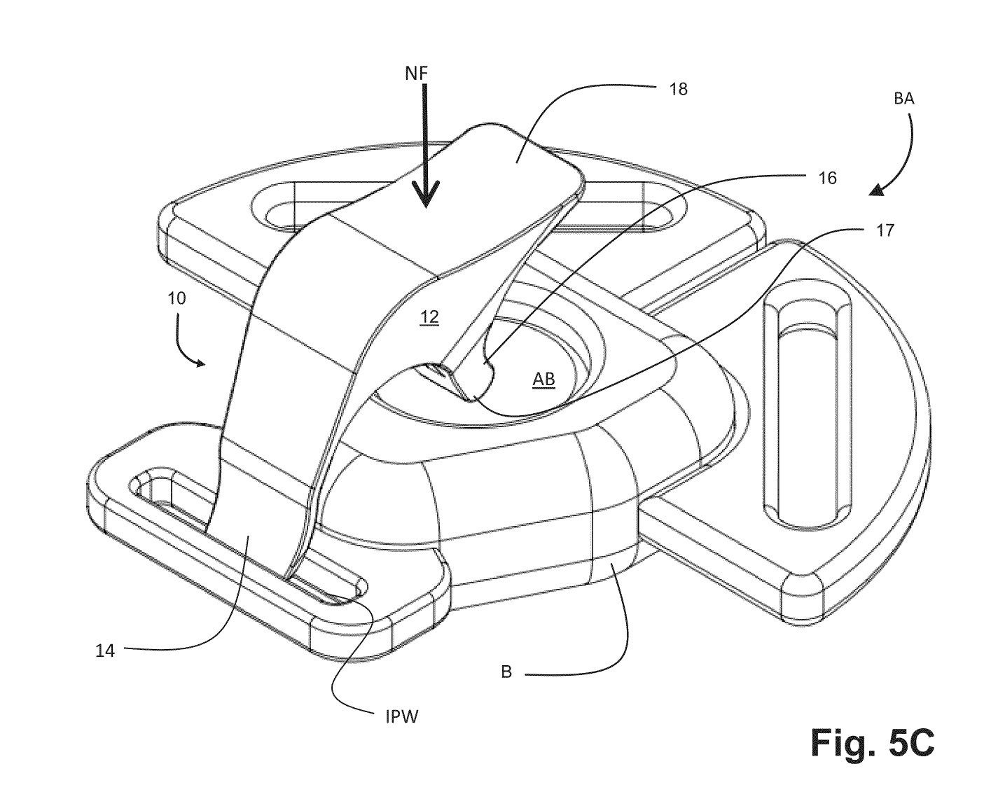

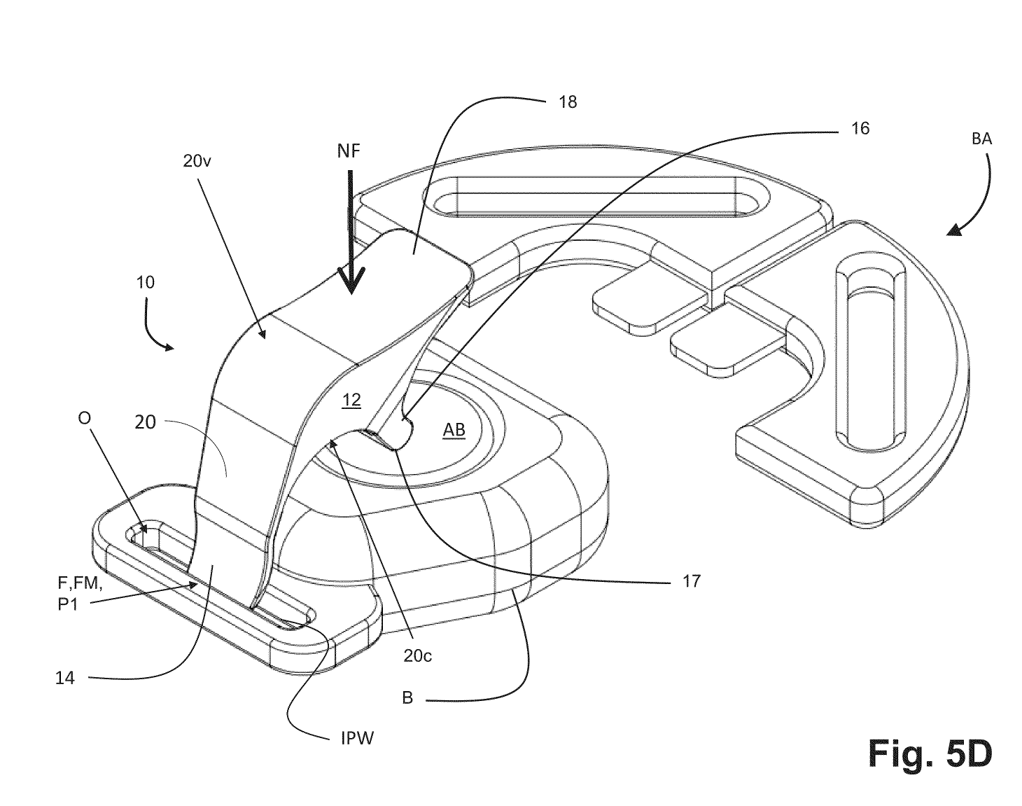

As shown in FIGS. 1 to 7E, embodiments of a buckle release tool 10 for unlatching a buckle release assembly BA are provided. The buckle release assembly BA (or buckle assembly for short) typically comprises a base B with an actuator button AB for activating a latching mechanism (not shown) from a latched position (e.g. FIGS. 5A to 5C) to an unlatched position (e.g FIG. 5D). The base B further comprises an opening O 14 along one side defined by an inner perimeter wall IPW therein. Typically, opening O is a slit-like elongate opening, as more clearly shown in FIG. 5B. The inner perimeter wall IPW may accept webbing (not shown) of a seat belt (also not shown), for connecting the base B of the buckle assembly BA to a seat (not shown).

The buckle release tool 10 comprises a structurally resilient body 12 for withstanding forces applied thereon. The body 12 has a first end 14, a second end 18, and an elongate member 16. Elongate member 16 has an engagement end 17 and is, preferably, spaced from the first and second ends 14, 18 along an arcuate arm 20. Engagement end 17 is suitable for engaging actuator button AB of the buckle assembly BA. Engagement end 17 may have a rounded surface providing a consistent point of contact between the engagement end 17 and the actuator button AB of the buckle assembly BA regardless of the angle at which the engagement end 17 is positioned on the buckle assembly BA.

First end 14 is suitably sized for at least partial placement in the opening O of the buckle assembly BA and for engagement with a portion of the inner perimeter wall IPW and/or any webbing that may be present therein. First end 14 is of such sizing and dimensions so that it does not completely fill opening O (and any webbing that may be present), so that first end 14 does not jamb or seize in opening O when inserted (but rather fit loosely therein).

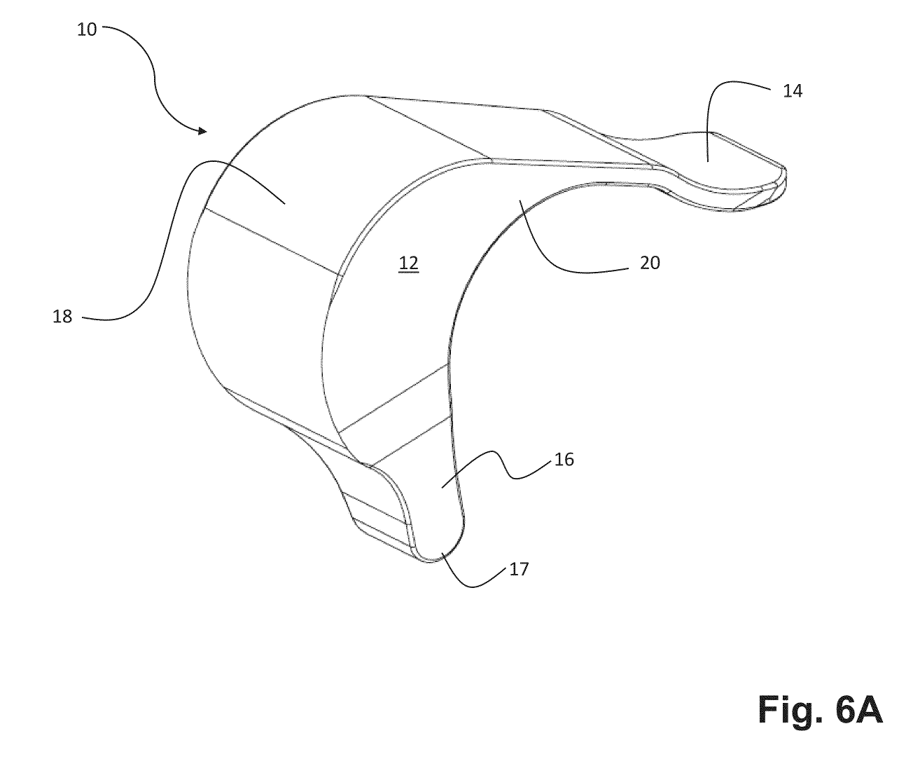

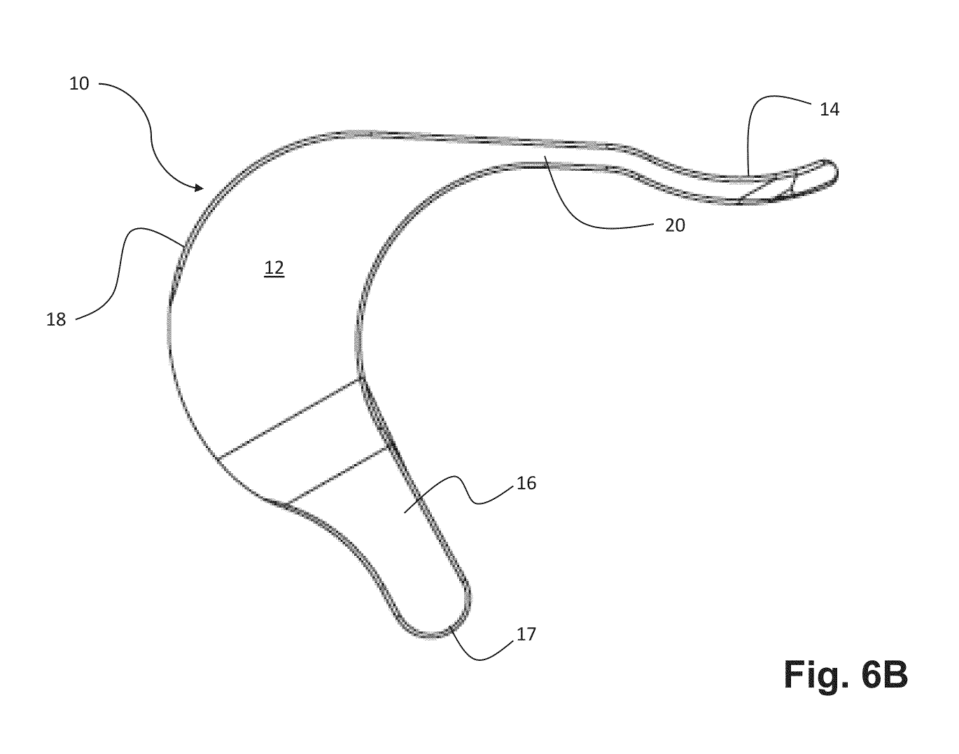

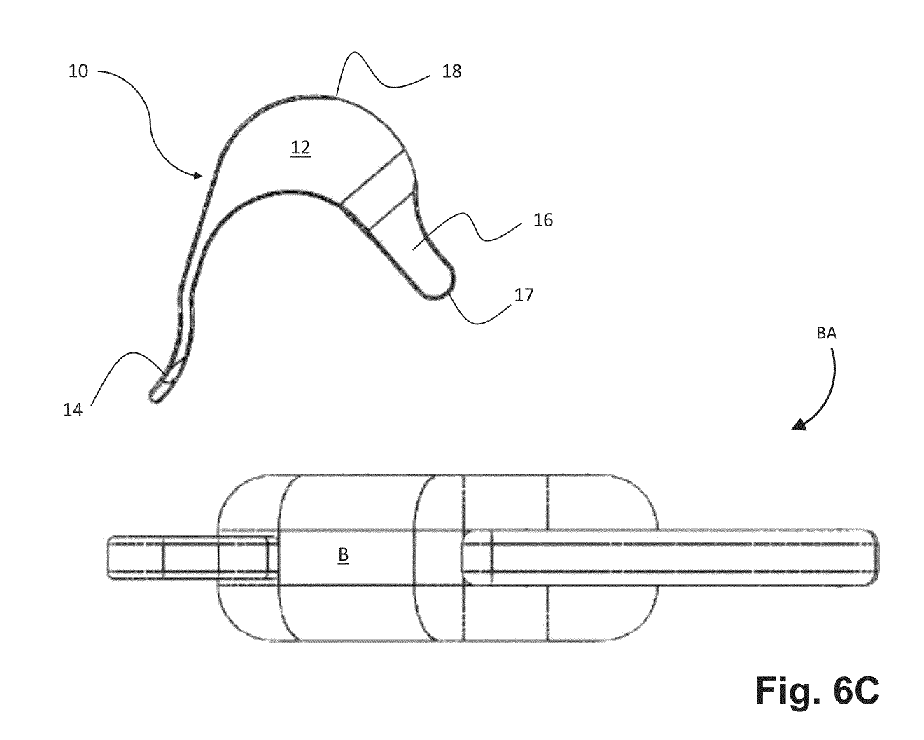

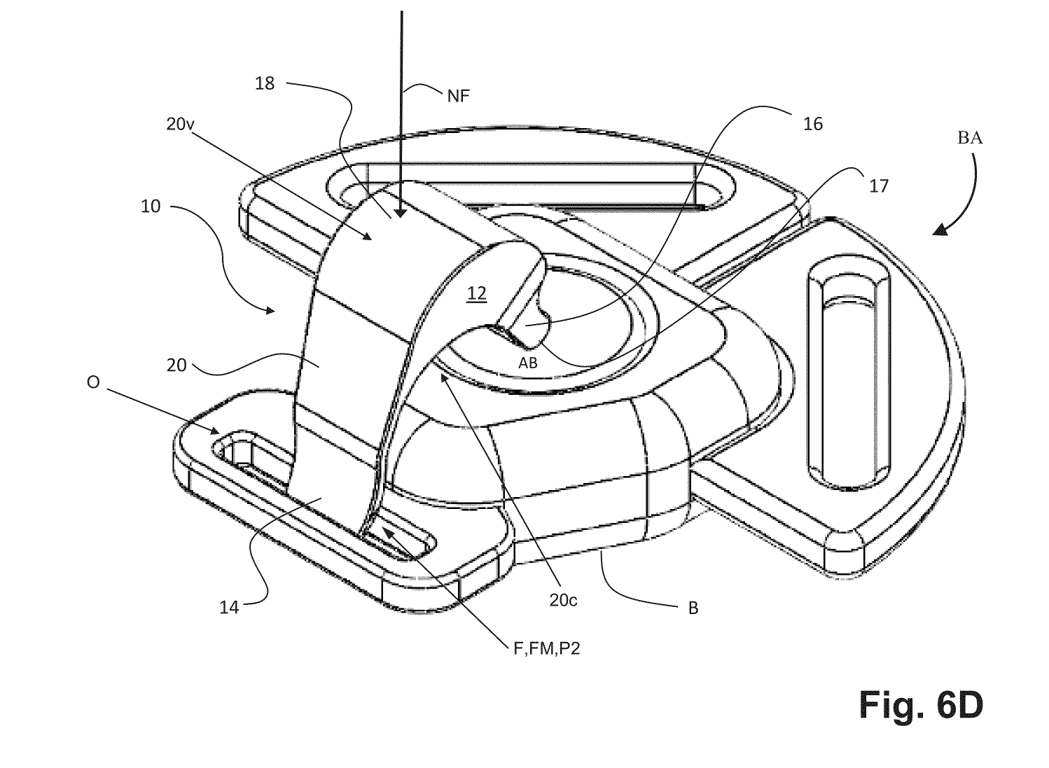

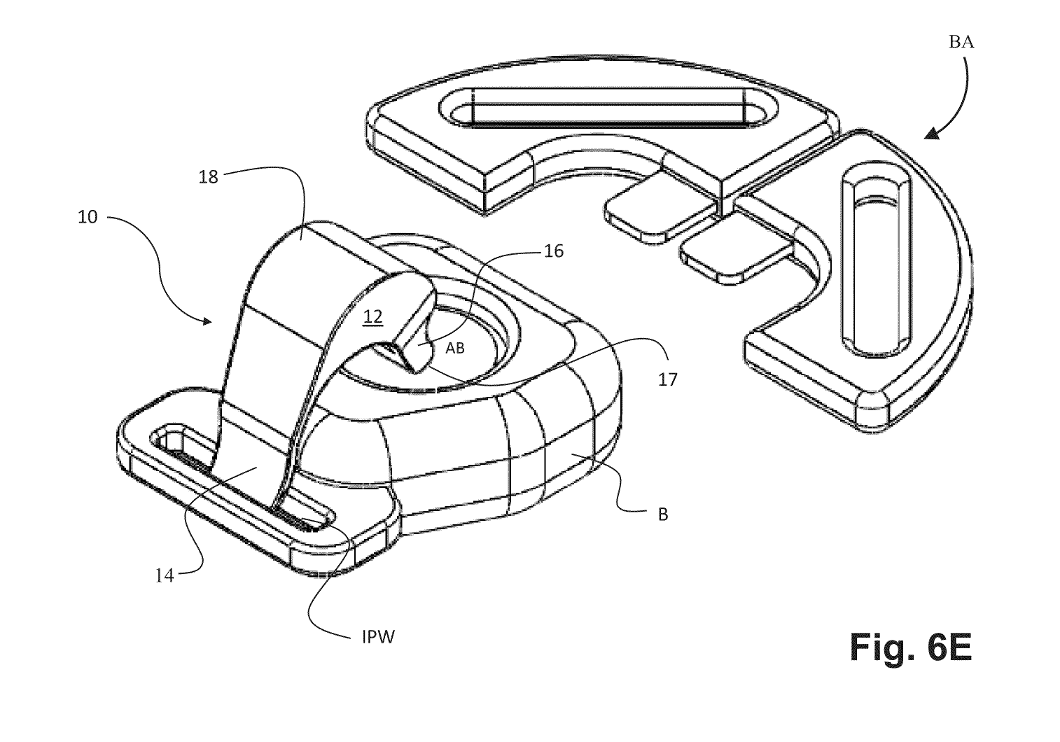

During operation of the buckle release tool 10, body 12 and first end 14 cooperate with opening O in the base B of the buckle assembly BA (or with some other fulcrum member FM on the base, such as a suitable ledge, shoulder, cavity, groove or the like) to allow body 12 to act as a lever against buckle assembly BA. Preferably the opening's inner perimeter wall IPW (or any webbing that may be present therein) provides a fulcrum F or pivot point for the body 12 to rotate about. The fulcrum F may be when first end 14 engages the inner perimeter wall IPW at a position most distal from the actuator button AB, e.g. at position P1 as shown in FIG. 5D. Alternatively, the fulcrum F may be when first end 14 engages the inner perimeter wall IPW at a position proximal to the actuator button AB, e.g. at position P2, as shown in FIG. 6D. In most cases during operation of the buckle release tool 10, body 12 forms a class 2 lever, with first end 14 at position P1 forming the fulcrum F, with second end 18 accepting an input force NF or effort and with engagement end 17 engaging the load or resistance of actuator button AB (e.g. see FIG. 5D). In other cases, the buckle release tool 10, may operate more like a class 3 lever, with first end 14 at position P2 forming the fulcrum F, with second end 18 accepting the input force NF or effort and with engagement end 17 engaging the actuator button AB (e.g. see FIG. 6D).

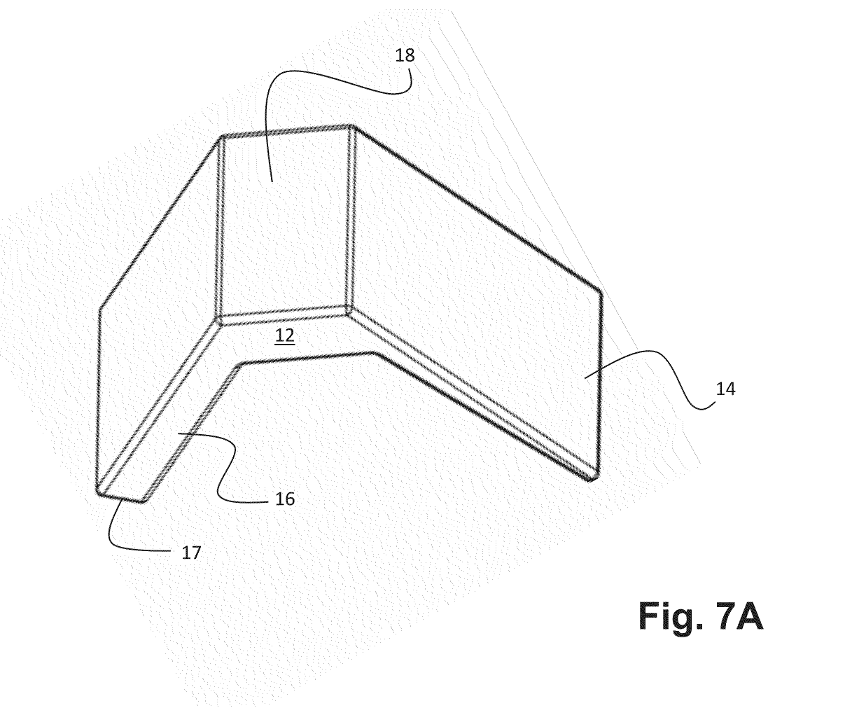

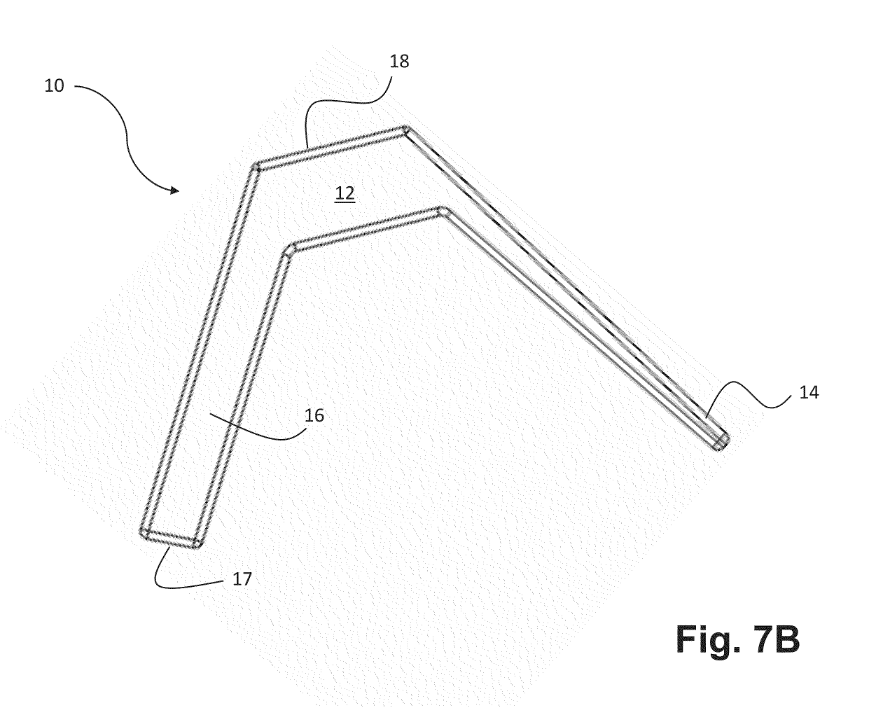

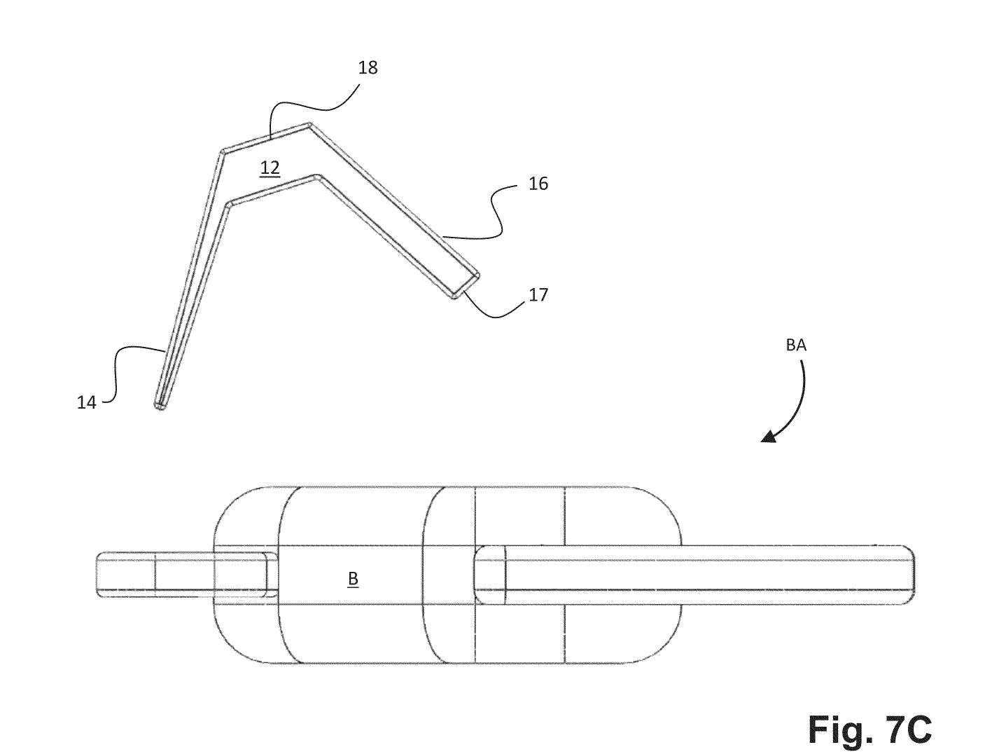

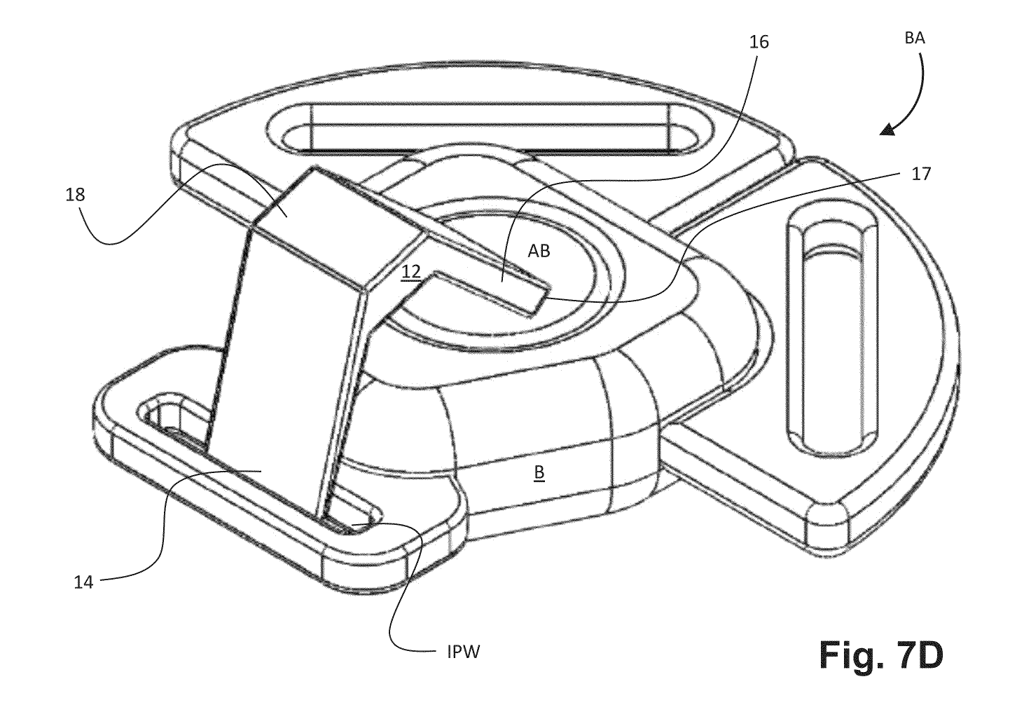

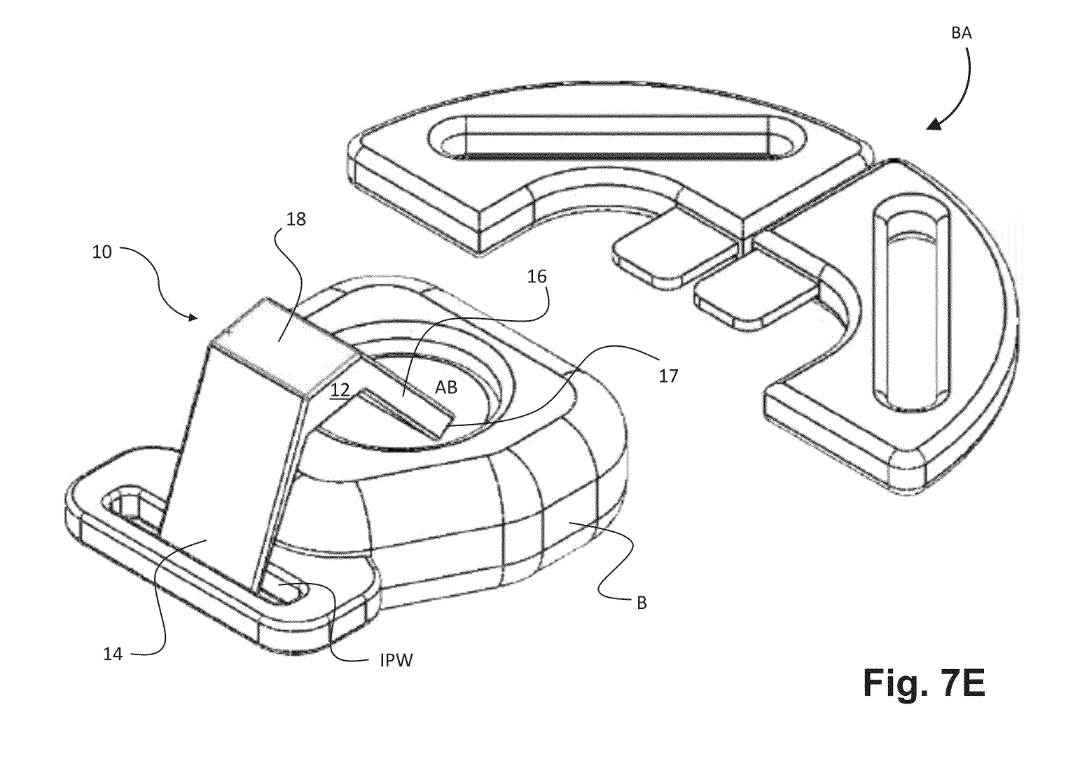

The width of the body 12 may be substantially uniform and may be predicated by the size of the first end 14. The second end 18 may have a planar surface for providing a user a comfortable surface with which to apply the input force NF thereon. The second end 18 may be in the same plane as the elongate member 16 (FIGS. 6A to 7E) or in the alternative, the second end 18 may be spaced S from the elongate member 16 opposite the first end 14 (FIGS. 1 to 5D). Advantageously, spacing S of second end 18 from elongate member 16 provide mechanical advantage when tool 10 is used as a lever, thereby reducing the input force NF a user may have to provide to operate the tool 10 to activate a latching mechanism. The first end 14 and the engagement end 17 are contact points between the buckle release tool 10 and the base of the buckle assembly.

The body 12 may be made from any structurally resilient material capable of maintaining its structural integrity while withstanding the required forces exerted thereon for actuating the actuator button AB. For example, the body 12 may be made from one or more materials including, but not limited to, one of a family of generic low-elasticity thermoplastic polymers suitable for injection molding such as injection molded polyethylene terephthalate (PET) or injection molded polypropylene (PP) plastic.

With reference to the embodiment of FIGS. 1-5D, the arcuate arm 20 extends between the first end 14 and second end 18 of the body 12 of the buckle release tool 10. The arcuate arm 20 preferably has a concave surface 20c and a convex surface 20v which provide the buckle release tool 10 with a compact design. Preferably, arcuate arm 20 provides improved angles for added efficiency when in operation, than if the body 12 had a more linear shape; e.g. while applying an input force NF (FIGS. 5C and 5D) on the second end 18 to engage the actuator button AB with the elongate member 16. Advantageously, the arcuate arm 20 and concave surface 20c provides the body 12 with sufficient clearance of the base B to allow proper depression of actuator button AB during operation. More advantageously, convex surface 20v provides the body 12 with an ergonomic shaped surface for when a user operates the buckle release tool 10. In the embodiment of FIGS. 1-5D the elongate member 16 is spaced from the first end 14 and extends from the concave surface 20c of the arcuate 20 of the body 12.

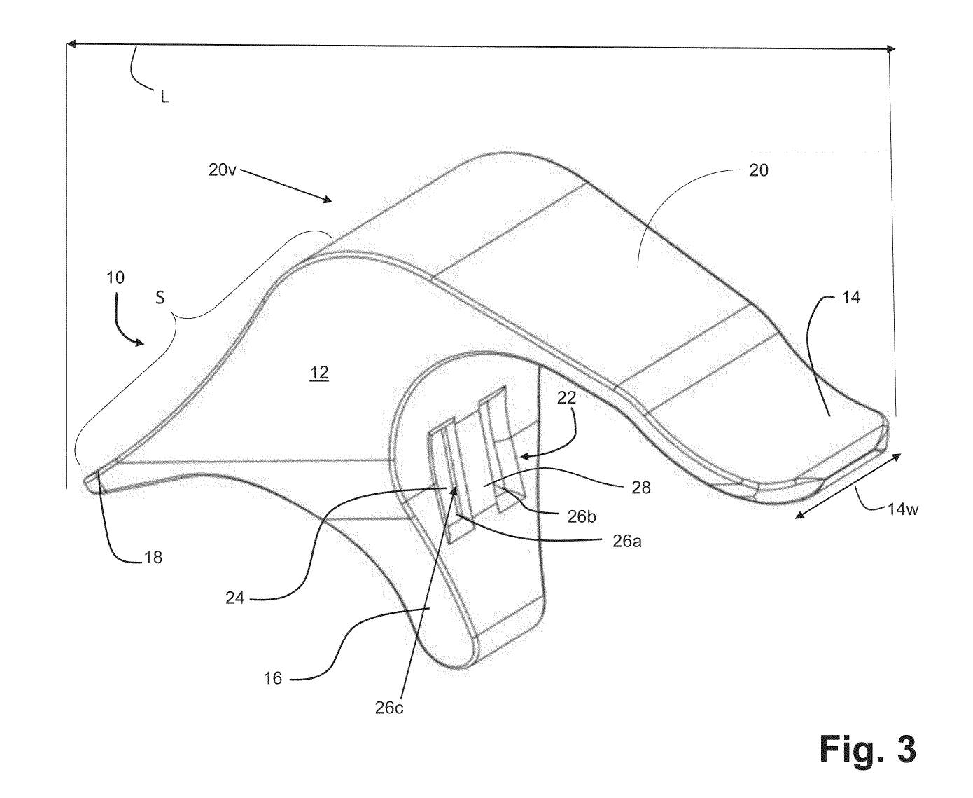

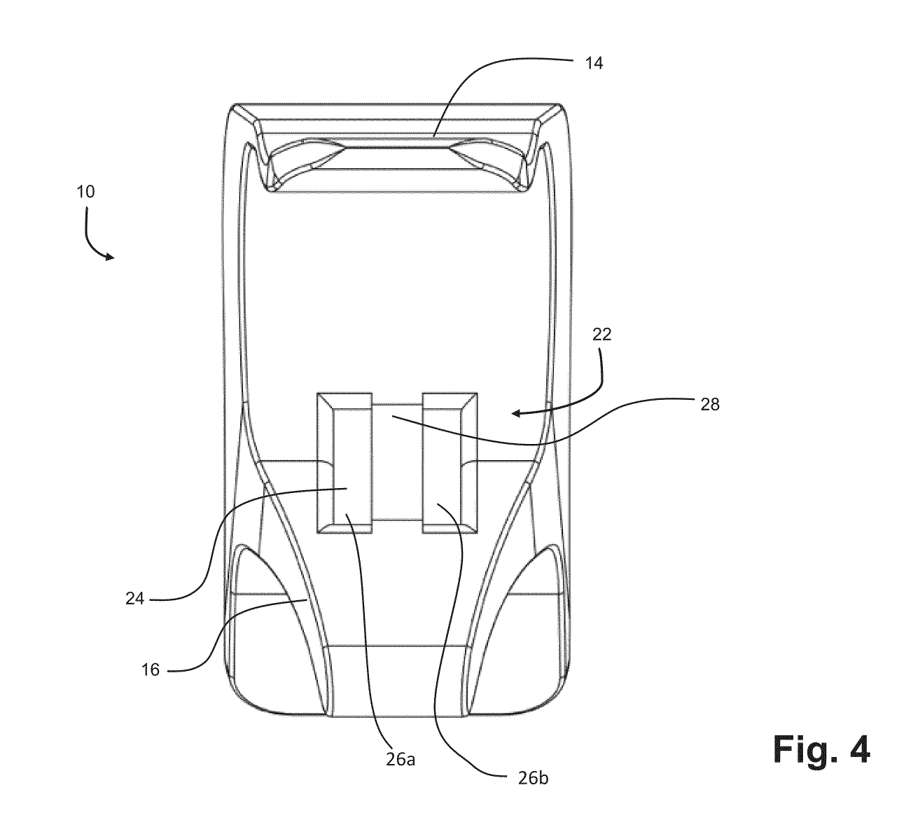

With reference to FIGS. 3 and 4, preferably an anchor point 22 is provided on the buckle release tool 10 for connecting a tensile member (not shown) thereon. As shown in FIG. 3, one embodiment of the anchor point 22 can be a blind hole 24 cut into one side of the elongate member 16 adjacent the first end 14. The blind hole 24 may have two parallel openings 26a, 26b on the surface of the elongate member 16 with a solid bridging structure 28 therebetween, so that parallel openings 26a, 26b are in communication with each other via a channel 26c. A tensile member such as a string, rope, ribbon, retractable lanyard, or the like (not shown) may be connected directly to the anchor point 22 of the buckle release tool 10. The tensile member may be connected to the anchor point 22 of the body 12 by inserting one end of the tensile member into one of the parallel openings 26a, through the channel 26c and out of the other parallel opening 26b. The one end of the tensile member may form a loop about the solid structure 28 and may attach to the length of the tensile member by any means as known to a person skilled in the art. Alternatively, a connector apparatus such as a hook, hook and loop fastener, key ring, or the like attached to the end of a tensile member may be used to secure the buckle release tool 10 to the tensile member.

Alternatively, the anchor point 22 may be located at various positions on the body 12 of the buckle release tool 10, as would be known in the art, so as not to interfere with the functioning of the buckle release tool 10 while actuating the actuator button. Also, the anchor point 22 may include various shapes and designs, as would be known in the art, such as a hole pierced through a section of the body 12 to loop the end of a tensile member or a key ring therethrough, or a loop protruding from the body 12 to provide a similar function.

In operation and as shown in FIGS. 5A to 5D, the buckle release tool 10 provides a way for changing the configuration of a buckle assembly BA from a latched position (FIGS. 5A-5C) to an unlatched position (FIG. 5D) in a more convenient manner than through use of the pre-existing actuator button alone.

Having reference to FIG. 5A, the buckle release tool 10 is positioned adjacent the buckle assembly BA such that the first end 14 is aligned with the opening O of the base B to engage the inner perimeter wall IPW and any webbing of the seat belt that may be present within the opening O. In alternate embodiments of the base B (not shown), first end 14 may instead engage some other kind of fulcrum member FM on the base, such as a suitable ledge, shoulder, cavity, groove or the like, instead of opening O. The engagement end 17 of the elongate member 16, is aligned with the actuator button AB of the buckle assembly BA. In this present configuration, the second end 18 is substantially parallel to the face of the base B and the actuator button AB of the buckle assembly.

FIG. 5B shows the buckle release tool 10 engaging the buckle assembly BA. Preferably, the first end 14 is positioned into the opening O of the base B provided. The opening O (or other suitable fulcrum member FM on the base, such as a ledge, shoulder, cavity, groove or the like) of the base B provides support for the first end 14 which acts as a fulcrum F for the buckle release tool 10 as it is being actuated. Advantageously, the buckle release tool 10, and concave surface 20c, straddles the section of the base B of the buckle assembly BA, between the opening O and the actuator button AB by the contact points of the first end 14 and the engagement end 17 of the elongate member 16. As previously mentioned above, the second end 18 is substantially parallel to the face of the base B and the actuator button BA of the buckle assembly AB. Furthermore, the second end 18 may be substantially positioned over the central axis of the actuator button AB. Alternatively, the second end 18 may be spaced from the elongate member 16 as to be positioned along any point parallel the plane of the surface of the base B and the actuator button AB as long as the displacement of the second end 18 does not interfere with the actuation of the button AB.

FIG. 5C shows the buckle release tool 10 after a input force NF or effort is applied to the second end 18. As illustrated in FIG. 5C, the input force NF applied to the second end 18 transfers through the buckle release tool 10 causing the tool 10 to function as a lever, via fulcrum F, and thereby causing actuator button AB to be displaced into the base B of the buckle assembly BA. Sufficient space between the body 12 and the base B between contact points provides appropriate clearance C for the body 12 of the buckle release tool 10 (over the base B) when the actuator button AB is pressed.

Finally, and with reference to FIG. 5D, the displacement of the actuator button AB activates a latching mechanism (not shown) from a latched position (FIGS. 5B and 5C) to an unlatched position (FIG. 5D). Once the actuator button AB is in an unlatched position, the buckles of the buckle assembly BA may be removed from the base B and the occupant may be removed from the seat.

### Example

In a preferred embodiment, as shown in FIGS. 1-5D, the buckle release tool 10 features the following dimensions. The length, or distance, between first end 14 and second end 18 is in the range of 45 mm to 60 mm. The first end 14 has a width 14w in the range of 10 mm to 20 mm and a thickness at its end 14t in the range of 1 mm to 5 mm. The distance D between first end 14 and engagement end 17 is in the range of 20 mm to 30 mm and the clearance C provided by concave surface 20c may be as much as 30 mm from line D.

### Alternative Embodiments

With reference to FIGS. 6A to 6E, an alternative embodiment of a buckle release tool 10 is provided. In the present embodiment, the second end 18 of the buckle release tool 10 of FIGS. 1 to 5D is not spaced from the elongate member 16. The absence of the spacing S of the second end 18 from the elongate member 16 in the present embodiment provide the buckle release tool 10 a more compact design. However, the absence of such space S also denies the user of some of the mechanical advantage provided by the spacing S second end 18 away from the elongate member 16. In order to compensate for the loss of mechanical advantage in the present embodiment, the user will be required to apply a greater input force NF to the second end 18 to active the actuator button AB of the buckle assembly BA.

With reference to FIGS. 7A to 7E, an alternative embodiment of a buckle release tool 10 is provided. In the present embodiment, not only has the space S between the second end 18 and the elongate member 16 absent, but the arcuate arm 20 that extends between the first end 14 and the elongate member 16 now features sharper corners 20sc and straight line section 201. Again, the absence of the space S accommodates a more simplified design than the previous embodiments. Although, the present embodiment shares the same loss of mechanical advantage as the previous embodiment of FIGS. 6A-6E, it provides about the same clearance C between the arm 20 spanning the first end 14 and the elongate member 16 and the base B of the buckle assembly BA.

Accordingly, disclosed and described the buckle release tool 10 provides a tool for use in depressing the pre-existing actuator button AB of a car seat restraint harness and releasing the buckle from the locking engagement of the car seat restraint harness in a more convenient manner than through use of the pre-existing actuator button alone. Application of the buckle release tool 10 is easily adapted for a variety of automotive vehicle occupant restraint systems including, but not limited to, child car seat restraint systems. The buckle release tool 10 can easily and conveniently be carried in a pocket or attached on the person using a lanyard.

What is claimed is:

1. A buckle release tool for unlatching a buckle assembly, the buckle assembly having a base with an actuator button, for activating a latching mechanism from a latched position to an unlatched position, the buckle assembly further having a fulcrum member, the buckle release tool comprising:
a body;
a first end on the body suitably sized for engaging the fulcrum member of the base for creating a fulcrum for the body to rotate about;
an engagement end, spaced from the first end and extending a sufficient amount from the body such that there is sufficient clearance of the body over the base to allow proper depression of actuator button by the engagement end during operation; and
a second end, for accepting a force thereon.

2. The buckle release tool of claim 1 wherein the second end is spaced from the elongate member, opposite the first end.

3. The buckle release tool of claim 1 wherein the body has a uniform width throughout predicated by the size of the first end.

4. The buckle release tool of claim 1 wherein the first end is tapered from the body toward the end to be a suitable thickness in the range of 1 mm to 5 mm.

5. The buckle release tool of claim 1 wherein, the second end further comprises a planar surface for accepting a force thereon.

6. The buckle release tool of claim 1 wherein, the body further comprises an anchor point for connecting a tensile member thereon.

7. The buckle release tool of claim 1 wherein, the body is an arcuate shape having a concave surface and a convex surface.

8. The buckle release tool of claim 1 wherein, the elongate member is spaced from the first end and extends from the concave surface of the arcuate shaped body for engaging the actuator.

9. The buckle release tool of claim 1 wherein, the elongate member is tapered from the body toward the engagement end.

10. The buckle release tool of claim 1 wherein, the engagement end is a rounded surface.

11. A buckle release tool system for unlatching a buckle assembly comprising:
a base on the buckle assembly, the base having an actuator button, for activating a latching mechanism from a latched position to an unlatched position, and a fulcrum member;
a buckle release tool with a body further comprising:
a first end suitably sized for engaging the fulcrum member of the base for creating a fulcrum for the body to rotate about,
an engagement end, spaced from the first end and extending a sufficient amount from the body such that there is sufficient clearance of the body over the base to allow proper depression of actuator button by the engagement end during operation, and
a second end, for accepting a force thereon;
wherein when an input force is applied to the second end, the body pivots about the fulcrum and the engagement end engages the actuator button of the buckle assembly.

12. The buckle release tool system of claim 11 wherein, the fulcrum member is an opening with inner walls, wherein webbing of a seat belt is provided through the opening covering a portion of the inner walls, and wherein the first end is suitable for engaging the webbing for defining the fulcrum for the body to rotate about.

13. The buckle release tool system of claim 11 wherein, the body further comprises an arcuate shape extending between the first end and the second end for providing said clearance between the body and the base.

14. The buckle release tool system of claim 11 wherein the second end is spaced from the elongate member, opposite the first end.

15. The buckle release tool system of claim 11 wherein the body has a uniform width throughout predicated by the size of the first end.

16. The buckle release tool of system claim 11 wherein the first end is tapered from the body toward the end to be a suitable thickness in the range of 1 mm to 5 mm.

17. The buckle release tool of system claim 11 wherein, the second end further comprises a planar surface for accepting a force thereon.

18. The buckle release tool of system claim 11 wherein, the body further comprises an anchor point for connecting a tensile member thereon.

19. The buckle release tool system of claim 18 wherein, the anchor point is located on the elongate member of the body.

20. The buckle release tool system of claim 18 wherein, the anchor point is positioned on the elongate member adjacent the first end.

21. The buckle release tool system of claim 11 wherein, the body is an arcuate shape having a concave surface and a convex surface.

22. The buckle release tool system of claim 21 wherein, the elongate member is spaced from the first end and extends from the concave surface of the arcuate shaped body for engaging the actuator.

23. The buckle release tool system of claim 11 wherein, the elongate member is tapered from the body toward the engagement end.

24. The buckle release tool system of claim 11 wherein, the engagement end is a rounded surface.

25. A method of actuating an actuator button of a buckle assembly, the assembly having a base with an actuator button for activating a latching mechanism from a latched position to an unlatched position, and a fulcrum member, the method comprising:
providing a buckle release tool;
placing a first end of a body of the buckle release tool against the fulcrum member to create a fulcrum;
engaging an elongate member, which is spaced from the first end, with the actuator button;
applying a input force to a second end of the body;
wherein when a input force is applied to the second end, the body pivots about the fulcrum so that the elongate member engages the actuator button of the buckle assembly.
